(19) United States
(12) Patent Application Publication
(10) Pub. No.: US 2015/0292244 A1
(43) Pub. Date: Oct. 15, 2015

(54) Proximity Padlock

(71) Applicant: Gleyn Beatty, Stouffville (CA)

(72) Inventor: Gleyn Beatty, Stouffville (CA)

(21) Appl. No.: 14/249,888

(22) Filed: Apr. 10, 2014

(51) Int. Cl. E05B 67/08; E05B 47/00

(52) U.S. Cl. CPC E05B 67/08; E05B 47/0012

(57) ABSTRACT

A padlock for wireless connection may include a wireless activated motor being activated remote from the padlock, a shackle being movable between an open position and a closed position by the wireless activated motor and a handheld device being wirelessly connected to the padlock to activate the wireless activated motor.

### FIELD OF THE INVENTION

The present invention relates to locks and more particularly to a padlock.

### BACKGROUND

A padlock is composed of a body, shackle, and a locking mechanism. The typical shackle is a “U” shaped loop of metal (round or square in cross-section) that encompasses what is being secured by the padlock (e.g., chain link or hasp). Generally, most padlock shackles either swing away (typical of older padlocks) or slide out of the padlock body when in the unlocked position. Unusually designed padlocks may include a straight, circular, or flexible (cable) shackles. Some shackles split apart and come together to lock and unlock.

There are two basic types of padlock locking mechanisms: integrated & modular. Integrated locking mechanisms directly engage the padlock's shackle with the tumblers. Examples of integrated locking mechanisms are rotating disks (found in “Scandinavian” style padlocks where a disk rotated by the key enters a notch cut into the shackle to block it from moving) or lever tumblers (where a portion of the bolt that secures the shackle enters the tumblers when the correct key is turned in the lock). Padlocks with integrated locking mechanisms are characterized by a design that does not allow disassembly of the padlock. They are usually older than padlocks with modular mechanisms and often require the use of a key to lock.

The more modern modular locking mechanisms, however, do not directly employ the tumblers to lock the shackle. Instead, they have a plug within the “cylinder” that, with the correct key, turns and allows a mechanism, referred to as a “locking dog” (such as the ball bearings found in American Lock Company padlocks) to retract from notches cut into the shackle. Padlocks with modular locking mechanisms can often be taken apart to change the tumblers or to service the lock. Modular locking mechanism cylinders frequently employ pin, wafer, and disk tumblers. Padlocks with modular mechanisms are usually automatic, or self-locking (that is, the key is not required to lock the padlock)

### SUMMARY

A padlock for wireless connection may include a wireless activated motor being activated remote from the padlock, a shackle being movable between an open position and a closed position by the wireless activated motor and a handheld device being wirelessly connected to the padlock to activate the wireless activated motor.

The padlock may include a crank being connected to the motor to move the shackle between the open position and the closed position.

The padlock may include a bearing to cooperate with the crank.

The padlock may include a spring to bias the crank.

The padlock may include a first radio to communicate with the handheld device.

The padlock may include a second radio to communicate with the handheld device.

The padlock may include a capacitive switch to open the padlock when a user touches the padlock.

The padlock may include a battery to supply power to the padlock.

The padlock may include a battery cover being internally lockable to prevent access to the battery.

The padlock may be controlled by a microprocessor.

The padlock cannot be locked within a predetermined distance from the handheld device.

The communication with the padlock may be authenticated with an authentication code.

The handheld device may be a smart phone.

The handheld device may grant a second handheld device a predetermined level of access.

The level of access may be for a period of time.

The level of access may be for one time.

The level of access may be for an infinite time.

### BRIEF DESCRIPTION OF THE DRAWINGS

The invention may be understood by reference to the following description taken in conjunction with the accompanying drawings, in which, like reference numerals identify like elements, and in which:

FIG. 1 illustrates a cross-sectional view of the padlock of the present invention in a first and locked position;

FIG. 2 illustrates a cross-sectional view of the padlock of the present invention in a second and unlocked position;

FIG. 3 illustrates an exploded view of the padlock of the present invention;

FIG. 4 illustrates the operation of the padlock of the present invention.

### DETAILED DESCRIPTION

The proximity padlock 100 operates with a wireless connection with the user and to remotely open and close the locking mechanism. The user does not need to physically enter a code or insert a key into the padlock 100. Instead the padlock 100 is opened by bringing in a handheld device 103 which may include a Smartphone or Smartcard within the proximity or a predetermined distance of the lock 100.

The lock 100 may be managed via a Smartphone App—IE to open, close, logs, etc., and the lock 100 may uses two (a first and second) radios—NFC 133 and Bluetooth 135—to allow for a broader compatibility base. For example, the ISO (Apple) and the Android can connect to the padlock 100 which may utilize a capacitive switch 105 for one touch opening. The lock 100 may send wirelessly (share) keys to another handheld device such as the Smartphone so the user of the receiving handheld device can open the padlock 100. An application which may be software operated by the microprocessor may actually communicate and with the back office system which sends the keys (token) and credentials to the second smartphone. The user of the second smart phone can then connect to the lock 100. The lock 100 may already has the keys (secondary key which is different from the primary) so it knows what to expect.

The padlock 100 may include a battery 107 which may be a large capacity lithium battery which may be sealed by an internal battery cover 109 which may lock internally which prevents access to the battery 107 and from the exterior of the padlock 100. The padlock 100 may utilize Near field communication (NFC) which is a set of standards for smartphones and similar devices to establish radio communication with each other by touching them together or bringing them into proximity, usually no more than a few inches and Secure Access Module SAM 128 (or Secure Application Module) is based on Smartcard ICs and is used to enhance the security and cryptography performance in devices, commonly in devices needing to perform secure transactions, such as paying terminals. It can be used for cryptographic computation and secure authentication against smart cards or contactless EMV cards. In addition the padlock 100 may include smartphone locking prevention in order to present the padlock 100 from locking a facility including the smartphone where locking prevention may help to stop the user from accidently locking their smartphone, the keys to the lock, in a locker or some other lockable box.

The padlock 100 may include a shackle 113 which may be substantially U-shaped for locking into the housing 111 of the padlock 100. The shackle 113 may cooperate with Ball bearings 115 which may be removable positioned into grooves 117 in the shackle 113 which prevents the shackle 113 from being opened to lock the padlock 100. The shackle 113 can be clapped around an object such as a locker securing it in place.

The padlock 100 may include a crank 119 which may be a cylinder having a pair of opposing cavities to cooperate with the ball bearings 115 and may be rotated by a motor 129 by virtue of a shaft. When the crank 119 is rotated to a position opposite the ball bearings 115, the ball bearings 115 are urged into the opposing cavities to allow the shackle 113 to be moved freely from a locked position to an unlocked position. The padlock 100 may include a spring 121 may be positioned to bias an arm of the shackle 113 to move from a locked position to an unlocked position by applying an pressure from the spring 121 on the shackle 113 to push the ball bearings 115 into the cavities of the crank 119.

The ball bearings 115 fit into grooves 117 in the shackle 113 which will not allow the shackle 113 to release. Once the crank 117 is turned the ball bearings 115 will move into the cavities in the crank 119.

The padlock 100 may include a sensor 131 positioned to cooperate with another arm of the shackle 113 and senses when the shackle returns into the lock housing 111 and activates the microprocessor 123 which may be mounted on the system board 125. The microprocessor 123 turns the crank 119 into the locked position forcing the ball bearings 115 back into the shackle 113.

The padlock 100 includes a motor 129 to rotate the crank 119 and may be a Micro Gear Motor to open the padlock 100 the micro gear motor turns the crank 119 which releases the ball bearings 115. When the shackle 113 has been returned to the housing 111 by the user, and in the sensor in the 131 senses the shackle 113 and activates the micro gear motor 129 by the microprocessor 123 to turn the crank 119 in the opposite direction locking the ball bearings 115 into the shackle 113.

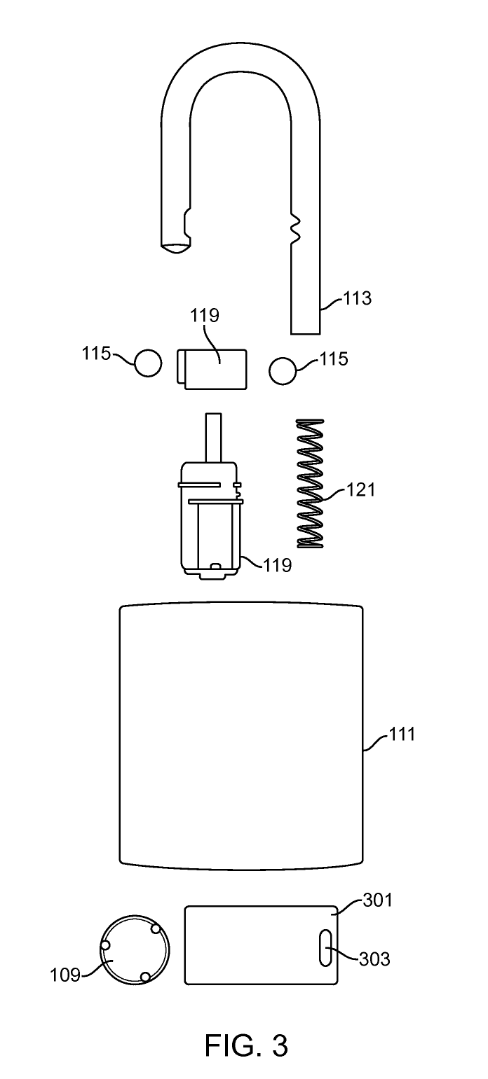

FIG. 3 illustrates an exploded view of the padlock 100 and illustrates the shackle 113, the ball bearings 115 the spring 121 and the micro gear motor 129. In addition, FIG. 3 illustrates the bottom wall 301 of the padlock 100 which may include an aperture 303 to allow a USB connection with the padlock 100.

The battery 107 powers the padlock 100 including the two radios and the micro gear motor.

The spring 121 may be compressed when the padlock 100 is locked. When the crank 119 is turned releasing the ball bearings 115, the spring 121 urges the shackle to the top of the housing 111.

The system board 125 includes the electronics and connections; radios, microprocessor, SAM, etc.

The USB 137 may be used as a backup power source if the battery were to fail.

A fastener Screw 139 may be used to block the battery lock bar from sliding locking the battery cover 109 in place.

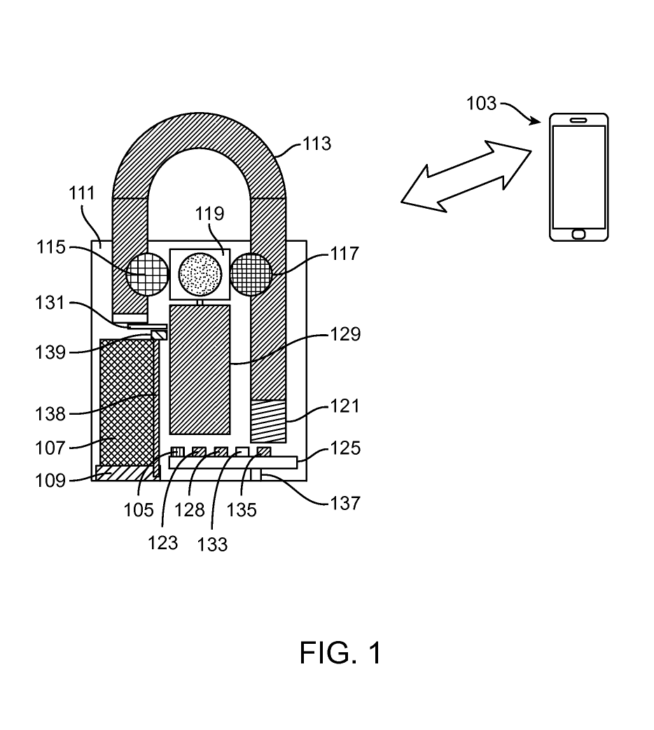

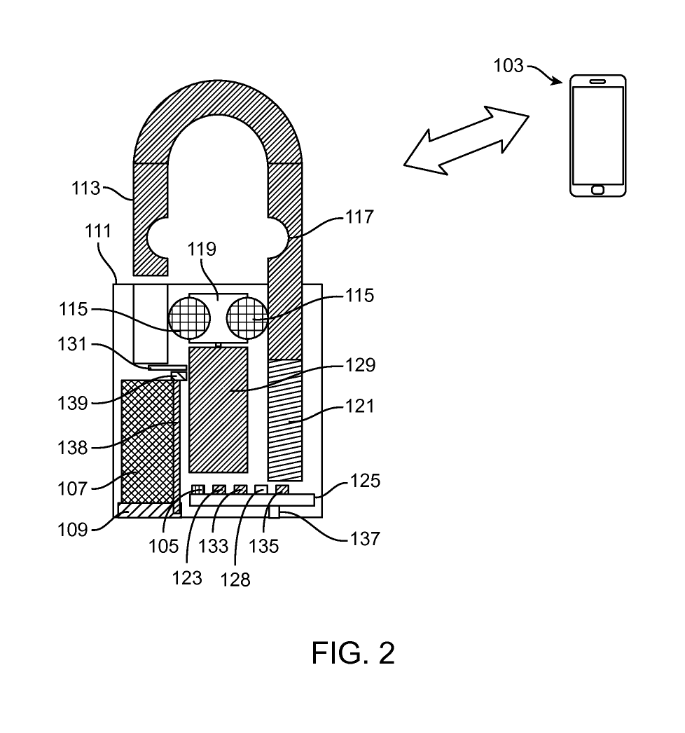

Lock Bar 138 is illustrated in FIGS. 1 and 2 adjacent to the battery and below the fastener screw 139 may be used in to hold the battery cover in place from the inside.

Battery Cover 109 may be used to replace the lithium battery every 3-5 years or sooner.

### Mechanics:

The padlock 100 may include a micro gear motor 129, a lithium battery 107, sensor 131 and radios 133 and 135 positioned on a system board. When the microprocessor 123 connected to a SAM 128 (Security Access Module) authenticates a user's electronic key (token) a command is sent to the micro geared motor 129 to rotate the crank 119. As the motor 129 rotates the motor 129 turns a crank 119 which releases the two ball bearings 115 allowing the spring loaded shackle 113 to be released. The spring 121 pushes the shackle 113 up opening the lock 100.

To close the lock 100, the user pushes the shackle 113 into the housing 111. When the sensor 131 senses the shackle 113, the microprocessor 123 turns the crank 113 which pushes the ball bearings 115 back into the shackle 113 locking the padlock 100.

### Battery Cover Lock:

A small round cover screws into the base of the padlock enclosure holding the battery in place. To ensure that the padlock 100 is not tampered with and the battery removed by someone that is not the rightful owner the battery cover is locked from the inside. A small bar 138 slides into the back of the battery cover preventing the cover from turning. The bar 138 runs up the side of the battery tube, beside the battery. A small screw blocks the bar from sliding out of place. The screw can only be removed when the padlock is unlocked and the shackle has been removed from the enclosure. With the screw removed the padlock 100 can be held upside down allowing the bar 138 to slide further into the enclosure and out of the back of the round battery cover. The battery cover can then be turned exposing the battery. Locking the battery is the opposite process. With the battery in the upright position the bar 138 will slide into the hole in the back of the battery cover locking it in place.

### Electronics:

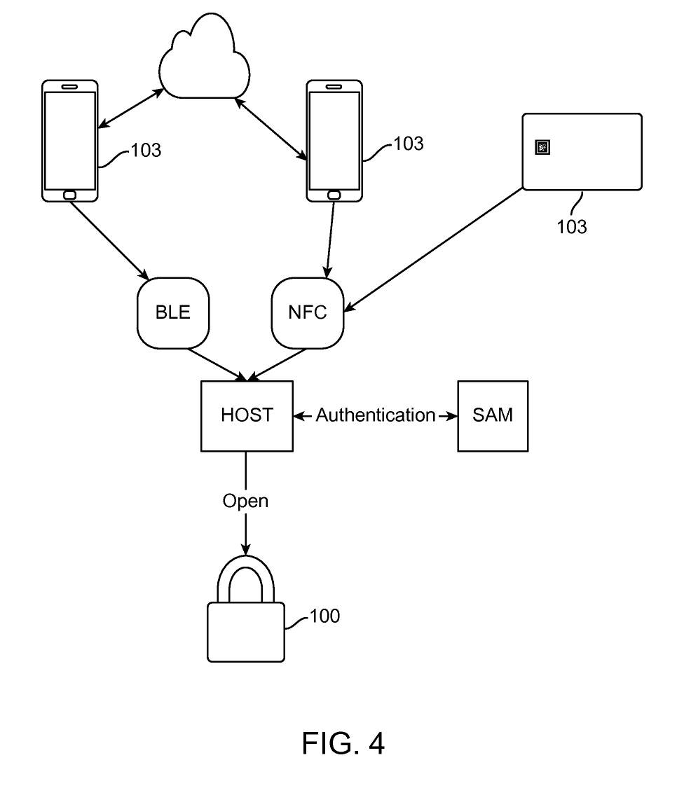

The components may include two radios, a microprocessor, a SAM (Security Access Module), a sensor a lithium battery and two antennas. The first radio may be a Near Field Communication (NFC) module and the second may be a Bluetooth 4.0 module (BLE) or later. The two radios 133, 135 allow the padlock 100 to communicate with both Android Smartphones as well as Apple products (iPhones, iPads, iPods, etc.) as shown in FIG. 4. The Smartphone connects to the lock via Bluetooth and authenticates through the SAM 128 prior to the user reaching the lock 100. When the user is standing at the lock 100 it is in fact already unlocked by virtue of the ball bearings 115 being withdrawn from the shackle 113. The user just needs to touch the shackle to open the lock 100.

The padlock 100 can also communicate with NFC based Smartcards. Smartcards include access cards, wristbands, decals and other devices which contain a NFC chip with a coil. BLE is used for platforms that do not support NFC or where the user chooses to use BLE over NFC.

A micro USB 137 is used to power the system in case the battery does not have enough power to open the lock 100.

### Capacitive Switch:

For users that are connecting to their padlock 100 via Bluetooth Low Energy (BLE) or higher they have the option, for some models to open the padlock 100 by just touching the lock 100. This is accomplished through the use of a capacitive switch 105. When a user touches the lock 100 they increase the overall capacitance of the padlock which is used as the switch 105 to open the lock. The microprocessor sends a command to the micro gear motor which turns the crank releasing the ball bearings and the shackle.

In the background, the user connects to the padlock 100 and authenticates the opening of the lock 100 by using Bluetooth as the user approaches the padlock. The microprocessor provides limited control over the capacitance switch. Once authenticated via Bluetooth the lock will open if touched by a finger. The switch may be able to sense the change when the finger is a predetermined distance such as few millimetres from the lock 100.

### Smartphone Locking Prevention:

To help ensure that you do not lock your Smartphone in your locker or other circumstances, the Padlock 100 may not lock when the Smartphone is within the Stage 2 area of 2-5 ft. This situation may be similar to a car that will not lock if you leave your car keys on the front seat. If you lock your Smartphone in your locker you would no longer have access to your locker.

When the shackle is pushed into the enclosure, the padlock 100 will close however it can be reopened by touching the lock 100. Once the Smartphone is no longer near the padlock 100, the ‘touch’ button is disabled. There may be a circumstance where you want to lock your Smartphone in your locker—football practice, swimming, or a shower. In this case, the user may use one of the alternative keys that came with the padlock 100—wristband or smartcard. By tapping the padlock 100 after it has been closed (shackle in the enclosure). The padlock 100 may be override the padlock's Smartphone proximity rule and lock the padlock. Upon returning to the lock 100, the user will tap the lock 100 with their wristband and the lock 100 will open.

### Authentication:

The SAM 128 (Security Access Module) is used to authenticate the user's credentials when they are connecting via a Smartphone (Apple, Android, Blackberry, Microsoft, etc.) or a Smartcard. The SAM 128 is part of the NFC authentication. Bluetooth is used for connecting some Smartphone models to the padlock; however NFC with the SAM is always used for authentication.

### Software:

An App (application) runs on a Smartphone (Apple, Android, Blackberry, Microsoft, etc.) device which controls access to the proximity padlock 100. Once the user installs and configures the App the padlock keys can be entered into the App.

When the user's Smartphone comes in contact with the padlock 100, the Smartphone will automatically connect and authenticate with the proximity padlock. Once connected the lock 100 can automatically be unlocked or a button on the App can be depressed to unlock the padlock 100. This is determined by configuration.

The lock user can grant access to other users by specifying the level of access that is granted to the users—a predetermined period of time, one off or indefinitely. A back office system pushes the authentication to the other users Smartphone.

Events are captured by the padlock 100 and sent to the users Smartphone as a log history. This allows the user to track the time and date that the padlock 100 was last opened and closed plus additional key events.

The proximity padlock 100 can be configured from the users Smartphone.

### Smartcards:

Smartcards do not require any software. The keys on the Smartcards are pre-registered on the padlock 100. Events created by the Smartcards are sent to the padlock owners Smartphone during the next connection.

### Security:

Keys are encrypted on the smartphone as well as on the padlock 100.

A token is created and sent between the back office system, the Smartphones and the padlocks. The user does not need to know the keys for the lock 100 once they have been entered. The token credentials are set to expire once the time limit set out by the owner has been exceeded.

### Bluetooth Connections:

Users who connect through a Bluetooth (currently 4.0 or BLE) connection, Apple products and some Smartphones, connect using a three stage approach.

### Stage 1—Bluetooth Connection

Once the user's Smartphone, which is running the App and is configured, comes in range of the padlock 100, the two devices will automatically pair and connect. This should occur between 12-30 ft. from the padlock 100.

In the background, the Padlock 100 will authenticate the user. The padlock will remain locked.

### Stage 2—Unlock

When the user is approximately 3 ft (2-5 ft.) from the padlock 100, the Bluetooth module will confirm their proximity and unlock but not open the padlock. At this point the lock can be opened by anyone who touches the lock.

Stage 2a—Bluetooth Connection/Unlock

Some brands and models of Smartphone may not support Bluetooth proximity. In this case, the connection and the ‘unlock’ occur at the same time in Stage 1.

### Stage 3—Open

When a user touches the padlock 100 with their finger (or comes within an inch or less), the lock 100 will open automatically. This is accomplished by using a capacitive switch (105) to detect the user's proximity to the padlock 100.

Stage 3a—App Button

The user can configure the App to open the padlock 100 when they press the ‘open’ button. This will override the touch sensor.

### Locking

The user locks the padlock 100 by pushing the shackle into the body of the padlock 100. This will engage the locking mechanism. The touch button will not be available for a predetermined time after the lock 100 has been locked so that the lock does not continue to attempt to open when a user touches the padlock. If the user needs to reopen the lock 100 immediately this can be done by selecting the button on the App.

### NFC Connection:

Smartphones that connect using NFC—Cards, bands and some Android Smartphones—do so in one stage. There are multiple parts to the stage however from the user's perspective it looks like one stage.

### Stage 1—Opening

When the user's phone comes within inches of the padlock 100, the two devices connect using a secure connection. The padlock 100 authenticates the user and automatically opens the padlock 100.

### Locking

The user locks the padlock 100 by pushing the shackle into the body of the padlock 100 which engages the locking mechanism. The NFC unlock functionality is temporarily disabled when the padlock 100 is unlocked so that the lock 100 does not continue to attempt to open when the user's smartphone comes in contact with the padlock 100. If the user needs to reopen the lock 100 immediately this can be done by selecting the button on the App.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed.

1. A padlock for a wireless connection, comprising:
a wireless activated motor being activated remote from the padlock;
a shackle being movable between an open position and a closed position by the wireless activated motor;
a handheld device being wirelessly connected to the padlock to activate the wireless activated motor.

2. A padlock for a wireless connection as in claim 1, wherein the padlock includes a crank being connected to the motor to move the shackle between the open position and the closed position.

3. A padlock for a wireless connection as in claim 2, wherein the padlock includes a bearing to cooperate with the crank.

4. A padlock for a wireless connection as in claim 1, wherein the padlock includes a spring to bias the crank.

5. A padlock for a wireless connection as in claim 1, wherein the padlock includes a first radio to communicate with the handheld device.

6. A padlock for a wireless connection as in claim 1, wherein the padlock includes a second radio to communicate with the handheld device.

7. A padlock for a wireless connection as in claim 1, wherein the padlock includes a capacitive switch to open the padlock when a user touches the padlock.

8. A padlock for a wireless connection as in claim 1, wherein the padlock includes a battery to supply power to the padlock.

9. A padlock for a wireless connection as in claim 8, wherein the padlock includes a battery cover being internally lockable to prevent access to the battery.

10. A padlock for a wireless connection as in claim 1, wherein the padlock is controlled by a microprocessor.

11. A padlock for a wireless connection as in claim 1, wherein the padlock cannot be accidently locked within a predetermined distance from the handheld device unless overridden by the associated wristband or Smartcard.

12. A padlock for a wireless connection as in claim 1, wherein the communication with the padlock is authenticated with an authentication code.

13. A padlock for a wireless connection as in claim 1, wherein the handheld device is a smart phone.

14. A padlock for a wireless connection as in claim 1, wherein the handheld device may grant a second handheld device a predetermined level of access.

15. A padlock for a wireless connection as in claim 14, wherein the level of access is for a period of time.

16. A padlock for a wireless connection as in claim 14 when the level of access is for one time.

17. A padlock for a wireless connection as in claim 14 wherein the level of access is for an infinite time.
